(19) United States
(12) Patent Application Publication
(10) Pub. No.: US 2024/0184293 A1
(43) Pub. Date: Jun. 6, 2024

(54) JUST-IN-TIME DESTINATION AND ROUTE PLANNING

(71) Applicant: Seegrid Corporation, Pittsburgh, PA (US)

(72) Inventors: Andy Christman, Pittsburgh, PA (US); Andrew DiFurio, Pittsburgh, PA (US); Francine Gemperle, Pittsburgh, PA (US); Atticus Huberts, Pittsburgh, PA (US); Jesse Legg, Pittsburgh, PA (US); Jay Liu, Pittsburgh, PA (US); Stephen Ramusivich, McMurray, PA (US); Jenna Sivak, Pittsburgh, PA (US)

(21) Appl. No.: 18/529,109

(22) Filed: Dec. 5, 2023

Related U.S. Application Data
(60) Provisional application No. 63/430,184, filed on Dec. 5, 2022.

(51) Int. Cl. G05D 1/02; G01C 21/20

(52) U.S. Cl. CPC G05D 1/0212; G01C 21/206

(57) ABSTRACT

A system and method are provided for a material flow automation process. In some embodiments, the system and/or method comprise: an input device that provides instructions of an instruction set regarding at least one destination of interest to at least one processor; a navigation system that navigates a vehicle in response to the instructions; and a controller that initiates a material flow task to be executed by the vehicle, wherein the controller receives at least one instruction of the instruction set during the execution of the material flow task by the vehicle.

### CROSS REFERENCE TO RELATED APPLICATIONS

This application claims priority to 63/430,184 filed on Dec. 5, 2022, entitled Just in time Destination Definition and Route Planning, the contents of which are incorporated herein by reference in their entirety.

The present application may be related to International Application No. PCT/US23/016556 filed on Mar. 28, 2023, entitled A Hybrid, Context-Aware Localization System For Ground Vehicles; International Application No. PCT/US23/016565 filed on Mar. 28, 2023, entitled Safety Field Switching Based On End Effector Conditions In Vehicles; International Application No. PCT/US23/016608 filed on Mar. 28, 2023, entitled Dense Data Registration From An Actuatable Vehicle-Mounted Sensor; International Application No. PCT/U.S. Pat. No. 23,016,589, filed on Mar. 28, 2023, entitled Extrinsic Calibration Of A Vehicle-Mounted Sensor Using Natural Vehicle Features; International Application No. PCT/US23/016615, filed on Mar. 28, 2023, entitled Continuous And Discrete Estimation Of Payload Engagement/Disengagement Sensing; International Application No. PCT/US23/016617, filed on Mar. 28, 2023, entitled Passively Actuated Sensor System; International Application No. PCT/US23/016643, filed on Mar. 28, 2023, entitled Automated Identification Of Potential Obstructions In A Targeted Drop Zone; International Application No. PCT/US23/016641, filed on Mar. 28, 2023, entitled Localization of Horizontal Infrastructure Using Point Clouds; International Application No. PCT/US23/016591, filed on Mar. 28, 2023, entitled Robotic Vehicle Navigation With Dynamic Path Adjusting; International Application No. PCT/US23/016612, filed on Mar. 28, 2023, entitled Segmentation of Detected Objects Into Obstructions and Allowed Objects; International Application No. PCT/US23/016554, filed on Mar. 28, 2023, entitled Validating the Pose of a Robotic Vehicle That Allows It To Interact With An Object On Fixed Infrastructure; and International Application No. PCT/US23/016551, filed on Mar. 28, 2023, entitled A System for AMRs That Leverages Priors When Localizing and Manipulating Industrial Infrastructure; International Application No.: PCT/US23/024114, filed on Jun. 1, 2023, entitled System and Method for Generating Complex Runtime Path Networks from Incomplete Demonstration of Trained Activities; International Application No.: PCT/US23/023699, filed on May 26, 2023, entitled System and Method for Performing Interactions with Physical Objects Based on Fusion of Multiple Sensors; International Application No.: PCT/US23/024411, filed on Jun. 5, 2023, entitled Lane Grid Setup for Autonomous Mobile Robots (AMRs); International Application No.: PCT/US23/033818, filed on Sep. 27, 2023, entitled Shared Resource Management System and Method; International Application No.: PCT/US23/079141, filed on Nov. 8, 2023, entitled System And Method For Definition Of A Zone Of Dynamic Behavior With A Continuum Of Possible Actins and Locations Within Same; International Application No.: PCT/US23/078890, filed on Nov. 7, 2023, entitled Method And System For Calibrating A Light-Curtain; International Application No.: PCT/US23/036650, filed on Nov. 2, 2023, entitled System and Method for Optimized Traffic Flow Through Intersections with Conditional Convoying Based on Path Network Analysis; U.S. Provisional Appl. 63/430,190 filed on Dec. 5, 2022, entitled Configuring a System That Handles Uncertainty with Human and Logic Collaboration in A Material Flow Automation Solution; U.S. Provisional Appl. 63/430,182 filed on Dec. 5, 2022, entitled Composable Patterns of Material Flow Logic for the Automation of Movement; U.S. Provisional Appl. 63/430,174 filed on Dec. 5, 2022, entitled Process Centric User Configurable Step Framework for Composing Material Flow Automation; U.S. Provisional Appl. 63/430,195 filed on Dec. 5, 2022, entitled Generation of “Plain Language” Descriptions Summary of Automation Logic; U.S. Provisional Appl. 63/430,171 filed on Dec. 5, 2022, entitled Hybrid Autonomous System Enabling and Tracking Human Integration into Automated Material Flow; U.S. Provisional Appl. 63/430,180 filed on Dec. 5, 2022, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); and U.S. Provisional Appl. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. patent application Ser. No. 11/350,195, filed on Feb. 8, 2006, U.S. Pat. No. 7,466,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; US Design Patent Appl. 29/398,127, filed on Jul. 26, 2011, U.S. Pat. No. D680,142, Issued on Apr. 16, 2013, entitled Multi-Camera Head; US Design Patent Appl. 29/471,328, filed on Oct. 30, 2013, U.S. Pat. No. D730,847, Issued on Jun. 2, 2015, entitled Vehicle Interface Module; U.S. patent application Ser. No. 14/196,147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 17/712,660, filed on Apr. 4, 2022, US Publication Number 2022/0297734, Published on Sep. 22, 2022, entitled Laterally Operating Payload Handling Device; U.S. patent application Ser. No. 16/892,549, filed on Jun. 4, 2020, U.S. Pat. No. 11,693,403, Issued on Jul. 4, 2023, entitled Dynamic Allocation And Coordination of Auto-Navigating Vehicles and Selectors; U.S. patent application Ser. No. 18/199,052, filed on May 18, 2023, Publication Number 2023/0376030, Published on Nov. 23, 2023, entitled Dynamic Allocation And Coordination of Auto-Navigating Vehicles and Selectors; U.S. patent application Ser. No. 17/163,973, filed on Feb. 1, 2021, US Publication Number 2021/0237596, Published on Aug. 5, 2021, entitled Vehicle Auto-Charging System and Method; U.S. patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, US Publication Number 2022/0100195, Published on Mar. 31, 2022, entitled Vehicle Object-Engagement Scanning System And Method; U.S. patent application Ser. No. 17/478,338, filed on Sep. 17, 2021, US Publication Number 2022/0088980, Published on Mar. 24, 2022, entitled Mechanically-Adaptable Hitch Guide; U.S. patent application Ser. No. 29/832,212, filed on Mar. 25, 2022, entitled Mobile Robot, each of which is incorporated herein by reference in its entirety.

### FIELD OF INTEREST

The present inventive concepts relate to the field of robotics and material flow planning that includes the use of autonomous mobile robots (AMRs) for material handling. In particular, the inventive concepts may be related to systems and methods that provide just-in-time destination and route planning.

### BACKGROUND

Within increasing numbers and types of environments autonomous vehicles may travel through areas and/or along pathways that are shared with other vehicles and/or pedestrians. Such other vehicles can include other autonomous vehicles, semi-autonomous vehicles, and/or manually operated vehicles. The autonomous vehicles can take a variety of forms and can be referred to using various terms, such as mobile robots, robotic vehicles, automated guided vehicles, and/or autonomous mobile robots (AMRs). In some cases, these vehicles can be configured for operation in an autonomous mode where they self-navigate or in a manual mode where a human directs the vehicle's navigation. Herein, vehicles that are configured for autonomous navigation are referred to as AMRs.

Multiple AMRs may have access to an environment and both the state of the environment, and the state of an AMR are constantly changing. The environment can be within, for example, a warehouse or large storage space or facility and the AMRs can include, but are not limited to, pallet lifts, pallet trucks, and tuggers.

Industrial AMRs need to use industrial controllers, that is, programmable logic controllers (PLCs), to achieve a higher level of automation. In order to fully leverage PLCs in industrial automation, they need to be integrated with a fleet management software. When enabling the integration, the integration can be done directly and specifically, or more generally. To enable more industrial automation, use cases, a generalized approach is required to abstract integration between industrial controllers and AMRs.

Material flow automation demands planning. However, the presence of complex dynamic environments including AMRs where material flow occurs requires engaging with uncertainty. Details of destinations and path plans often cannot be “known” upfront before AMR motion begins. Certainty about a desired path or the destination may be received from a variety of sources, such as human, intra-system, spontaneous parallel system inputs, etc. It is desirable that material flow processes be maintained, even in uncertain conditions.

In the most basic form, in order to automate the movement of materials in the presence of uncertain conditions, it is nevertheless necessary to be able to specify where something currently is and where it needs to go. Where the material is, or where it will be when it needs to be picked up, as well as where it needs to go are not always known when instructing the AMR to perform work. The creation of such an AMR instruction requires a large number of rules to complete a movement.

Nevertheless, in order to optimize the use of AMRs, it is necessary to have them start moving before all of the information is known. When tasking an AMR with work that needs to be done before all of the information is known, there needs to be a way to fill in the missing information as the AMR is in route. Conventional material flow automation systems require a plan to be provided prior to the start of a robotic task such that an uncertainty is prohibited.

Previous attempts to address this problem required all of the possible logical permutations needed to be defined during implementation. As described above, the creation of such an AMR instruction requires a large number of rules to complete a movement and the logic permutations require “if this then that” statements, which are technical and brittle. Rule complexity and proliferation lengthens AMR deployment times, increases system errors, and hinders user adoption and comprehension. There are often repeated patterns across customer facilities and each user of this rule based system may create a different set of rules to accomplish the exact same workflow. All of these logical possibilities in the backend may be presented to the user who has a mechanism to make a decision at each possible logic branch. This system is very difficult to implement and nearly as difficult to use.

For example, a conventional approach to Fleet Management using this “if this, then that” approach will provide users with a set of triggers, actions, and entities for data store to compose a rule with. To create this workflow, users will need to create a set of rules that enable the following behavior: 1) when an input is received queue a request, 2) when an AMR becomes available at a specific set of locations and is not currently performing other work assign it any queued work, 3) when there is no queued work and an AMR becomes available send the AMR to a location to wait at. While there are three primary behaviors users must create using rules, depending on the types of triggers, actions, and data stores the system provides, each behavior might take several rules to implement. For example, to implement “2”, the rules might be, “If an AMR arrives at station x and is not assigned a tag indicating it's on a job (data store used to set a flag on a vehicle) and the work queue is not empty, then assign the AMR the follow in the first item in the queue and remove that item from the queue and assign that AMR a tag indicating it is on a job.” This example conventional system does not support mixing AND and OR logic in triggers so, a variation of this rule will need to be created for each station the AMR can become available at and assigned a route. This conventional approach has several drawbacks. User must be familiar enough with the available triggers, actions, and data stores to come up with a set of rules to enable the behavior they desire. They must be technically capable enough to create “If this, then that” logic, which is similar in difficulty to simple programming. It is challenging for someone previously unfamiliar with the rules a user created to understand the behavior the rules are enabling.

Although flexible, allowing for the creation of any AMR instruction, an “if this then that” approach is time consuming, a large number of rules may be required to complete a movement, and “if this then that” statements are technical and brittle. Rule complexity and proliferation lengthens AMR deployment times, increases system errors, and hinders user adoption and comprehension. There are often repeated patterns across customer facilities and each user of this rule based system may create a different set of rules to accomplish the exact same workflow.

### SUMMARY

In accordance with various aspects of the inventive concepts, provided is a system including an input device that provides an instruction set regarding at least one destination of interest to at least one processor; a navigation system that navigates a vehicle in response to the instruction set; and a controller that initiates a material flow task to be executed by the vehicle. The controller receives at least one instruction of the instruction set during the execution of the material flow task by the vehicle.

In various embodiments, the vehicle is an autonomous mobile robot (AMR).

In various embodiments, the instruction set is output to the vehicle and a human or machine operator of the AMR controls the navigation system according to the instruction set.

In various embodiments, a task plan includes data about the material flow task and includes a combination of known and unknown information about a route, destination, and robotic action of the material flow task.

In various embodiments, the input device communicates with a plurality of different input sources, and wherein the controller parses and prioritizes multiple delayed inputs of the different input sources to the task plan.

In various embodiments, the unknown information is resolved by the at least one instruction during the execution of the material flow task.

In various embodiments, the system further comprises a user interface that receives data for addressing the unknown information while the vehicle is moving along a route for performing the material flow task.

In accordance with other aspects of the inventive concepts, provided is a method comprising starting a movement by the vehicle, the vehicle includes a plan including a combination of known and unknown features of a path to at least one destination of interest; providing an instruction set to the vehicle regarding information about the unknown features after the start of movement of the vehicle; and navigating the vehicle to the at least one destination of interest.

In accordance with other aspects of the inventive concepts, provided is computer readable medium having computer executable instructions for a material flow planning system that when executed by a processor performs the following steps comprising: starting a movement by the vehicle, the vehicle includes a plan including a combination of known and unknown features of a path to at least one destination of interest; providing instructions to the vehicle regarding information about the unknown features after the start of movement of the vehicle; and navigating the vehicle to the at least one destination of interest.

### BRIEF DESCRIPTION OF THE DRAWINGS

The present inventive concepts will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a perspective view of an embodiment of an AMR that comprises an embodiment of the systems described herein, in accordance with aspects of the inventive concepts.

FIG. 2 is a block diagram of an AMR, in accordance with aspects of the inventive concepts.

FIG. 3 illustrates an example of a warehouse environment in which embodiments of the present inventive concepts can be practiced.

FIG. 4 is a flow diagram of a material flow automation process, in accordance with aspects of inventive concepts.

FIG. 5 is a block diagram of a system for implementing a material flow operation based on just-in-time information, in accordance with some embodiments.

FIG. 6 is a flow diagram of a method for performing a material flow job by an AMR, in accordance with some embodiments.

FIG. 7 is a flow diagram of a method for starting a material flow job and entering information to a running job, in accordance with some embodiments.

FIG. 8 is a screenshot of a user interface of a material flow planning system, in accordance with some embodiments.

### DETAILED DESCRIPTION OF PREFERRED EMBODIMENTS

Various aspects of the inventive concepts will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

In brief overview, in accordance with aspect of the inventive concepts, a flexible system is provided that allows for uncertainty in a material flow such that the material flow may be maintained in an unknown path or destination. The core material elements of a plan such as a destination or route plan, and actions such as pick and drop, may have known and unknown states and result in uncertainty along a route due to unknown path or destination conditions. Here, the system is able to accept just-in-time information from a variety of human and non-human sources while the job is underway, e.g., the robot has already started to move, to eliminate uncertainty along the travel path to execute a material flow “job” or robotic task. In doing so, the system can parse and prioritize among the multiple different sources of input while the job is being executed and while the robot is in motion along a travel path. Conventional material flow automation systems, on the other hand, prohibits uncertainty such that the robot cannot begin to move if the destination or travel path is unknown and cannot process information that resolves the uncertainty about the destination or travel path after the robotic task has started.

The systems and methods of the present inventive concepts can provide information to an AMR or vehicle operator, with or without human involvement, during runtime (rather than requiring the information prior to the start of the task) in a manner that is simpler to configure, use, and to comprehend. An AMR can be tasked with an operation before all the information to perform the task is performed by providing the missing information when the AMR is en route. As described above, conventional approaches require every logical branch to be defined and accounted for. Then at runtime, an operator is required to act for every logical branch at each step in the process. The systems and methods of the present inventive concepts drastically limit the number of steps that require input as well as simplify the type of input that is being provided at each step. Conventional systems are constructed with the full understanding that an AMR is being used to accomplish work and as such required the user to think about the process in terms of how an AMR operates. The systems and methods of the present inventive concepts abstract away the notion that an AMR is doing work and in turn removes the need to think about the process in terms of what a robot is doing. The systems and methods of the present inventive concepts can alternatively generate instructions for output to human PIT operators.

The process of modeling repeatable tasks for robots to perform is described in greater detail in co-filed application entitled “A Process Centric User Configurable Step Framework for Composing Material Flow Automation,” attorney docket number SGR-060, which is hereby incorporated above by reference in its entirety. The process of indicating the source of specific location information is described in greater detail in co-filed application entitled “A Method for Abstracting Integrations Between Industrial Controls and AMRs,” attorney docket number SGR 064PR, which is hereby incorporated above by reference in its entirety.

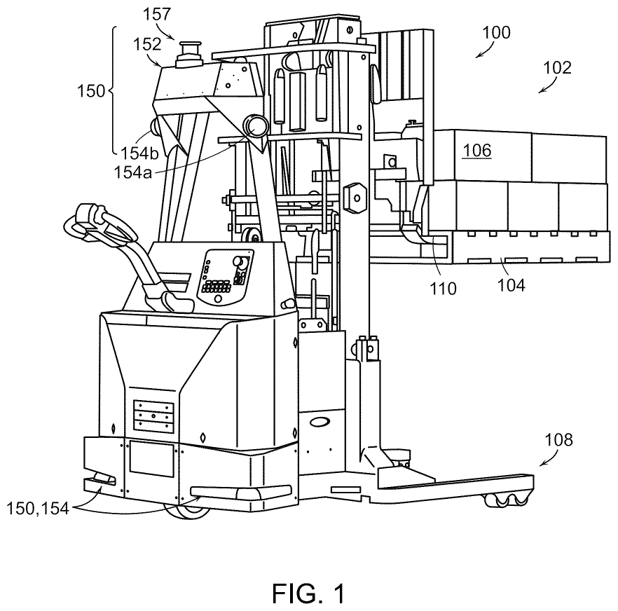

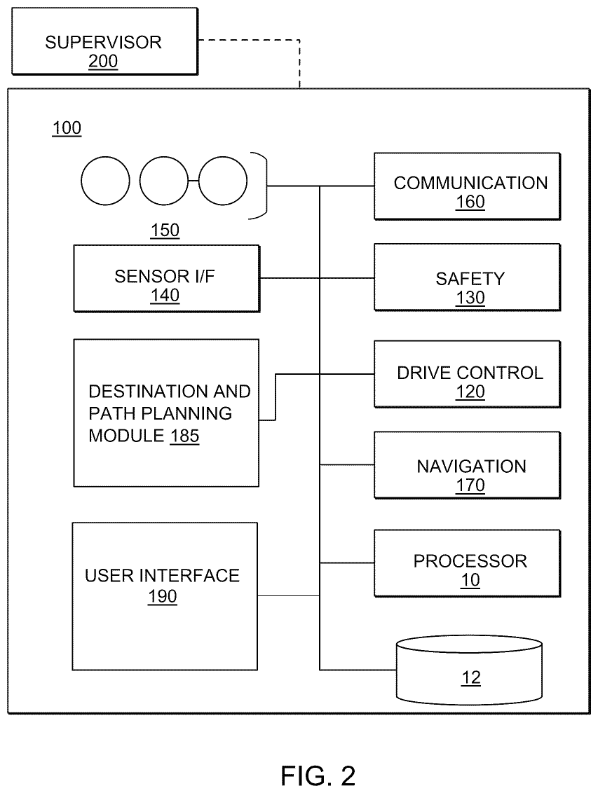

Referring to FIGS. 1 and 2, shown is an example of a self-driving or robotic vehicle in the form of an AMR lift truck 100 that is equipped and configured to drop off and pick up objects, such as palletized loads or other loads, in accordance with aspects of the inventive concepts. Although the robotic vehicle can take the form of an AMR lift truck 100, the inventive concepts could be embodied in any of a variety of other types of robotic vehicles and AMRs, including, but not limited to, forklifts, tow tractors, tuggers, and the like.

In this embodiment, AMR 100 includes a payload area 102 configured to transport any of a variety of types of objects that can be lifted and carried by a pair of forks 110. Such objects can include a pallet 104 loaded with goods 106, collectively a “palletized load,” or a cage or other container with fork pockets, as examples. Outriggers 108 extend from the robotic vehicle 100 in the direction of forks 110 to stabilize the AMR, particularly when carrying palletized load 104,106.

Forks 110 may be supported by one or more robotically controlled actuators coupled to a carriage 114 that enable AMR 100 to raise and lower, side-shift, and extend and retract to pick up and drop off objects in the form of payloads, e.g., palletized loads 104,106 or other loads to be transported by the AMR. In various embodiments, the AMR may be configured to robotically control the yaw, pitch, and/or roll of forks 110 to pick a palletized load in view of the pose of the load and/or horizontal surface that supports the load. In various embodiments, the AMR may be configured to robotically control the yaw, pitch, and/or roll of forks 110 to pick a palletized load in view of the pose of the horizontal surface that is to receive the load.

The AMR 100 may include a plurality of sensors 150 that provide various forms of sensor data that enable the AMR to safely navigate throughout an environment, engage with objects to be transported, and avoid obstructions. In various embodiments, the sensor data from one or more of sensors 150 can be used for path navigation and obstruction detection and avoidance, including avoidance of detected objects, hazards, humans, other robotic vehicles, and/or congestion during navigation.

One or more of sensors 150 can form part of a two-dimensional (2D) or three-dimensional (3D) high-resolution imaging system used for navigation and/or object detection. In some embodiments, one or more of the sensors can be used to collect sensor data used to represent the environment and objects therein using point clouds to form a 3D evidence grid of the space, each point in the point cloud representing a probability of occupancy of a real-world object at that point in 3D space.

In computer vision and robotic vehicles, a typical task is to identify specific objects in a 3D model and to determine each object's position and orientation relative to a coordinate system. This information, which is a form of sensor data, can then be used, for example, to allow a robotic vehicle to manipulate an object or to avoid moving into the object. The combination of position and orientation is referred to as the “pose” of an object. The image data from which the pose of an object is determined can be either a single image, a stereo image pair, or an image sequence where, typically, the camera as a sensor 150 is moving with a known velocity as part of the robotic vehicle.

Sensors 150 can include one or more stereo cameras 152 and/or other volumetric sensors, sonar sensors, radars, and/or LiDAR scanners or sensors 154a, 154b positioned about AMR 100, as examples. Inventive concepts are not limited to particular types of sensors, nor the types, configurations, and placement of the AMR sensors in FIGS. 1 and 2. In some embodiments, object movement techniques (i.e., dropping an object in the zone, removing an object from a zone) described herein are performed with respect to one or more of sensors 150, in particular, a combination of object detection sensors and load presence sensors. The object detection sensor(s) is/(are) configured to locate a position of an object withing the zone. An object detection sensor can be or include at least one camera, LiDAR, electromechanical, and so on. The load presence sensor(s) is/(are) configured to determine whether AMR 100 is carrying an object.

In the embodiment shown in FIG. 1, at least one of LiDAR devices 154a,b can be a 2D or 3D LiDAR device for performing safety-rated forward obstruction sensing functions. In alternative embodiments, a different number of 2D or 3D LiDAR devices are positioned near the top of AMR 100. Also, in this embodiment a LiDAR 157 is located at the top of the mast. In some embodiments LiDAR 157 is a 2D LiDAR used for localization or odometry-related operations.

The object detection and load presence sensors can be used in combination with others of the sensors, e.g., stereo camera head 152. Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

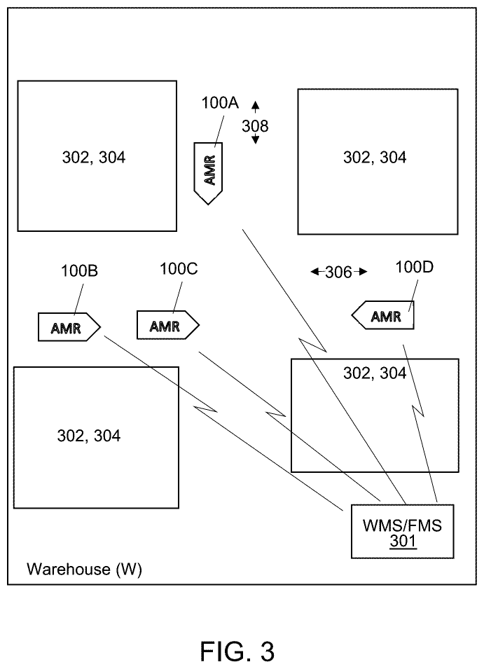

FIG. 3 is a block diagram of components of an embodiment of AMR 100 of FIG. 1, incorporating technology for moving and/or transporting objects (e.g., loads or pallets) to/from a predefined zone, in accordance with principles of inventive concepts. In the example embodiment shown in FIGS. 1 and 2, AMR 100 is a warehouse robotic vehicle, which can interface and exchange information with one or more external systems, including a supervisor system, fleet management system, and/or warehouse management system (collectively “supervisor 200”). In various embodiments, supervisor 200 could be configured to perform, for example, fleet management and monitoring for a plurality of vehicles (e.g., AMRs) and, optionally, other assets within the environment. Supervisor 200 can be local or remote to the environment, or some combination thereof.

In various embodiments, supervisor 200 can be configured to provide instructions and data to AMR 100, and to monitor the navigation and activity of the AMR and, optionally, other AMRs. The AMR can include a communication module 160 configured to enable communications with supervisor 200 and/or any other external systems. Communication module 160 can include hardware, software, firmware, receivers, and transmitters that enable communication with supervisor 200 and any other external systems over any now known or hereafter developed communication technology, such as various types of wireless technology including, but not limited to, Wi-Fi, Bluetooth™, cellular, global positioning system (GPS), radio frequency (RF), and so on.

As an example, supervisor 200 could wirelessly communicate a path for AMR 100 to navigate for the vehicle to perform a task or series of tasks. The path can be a virtual line that the AMR is following during autonomous motion. The path can be relative to a map of the environment stored in memory and, optionally, updated from time-to-time, e.g., in real-time, from vehicle sensor data collected in real-time as AMR 100 navigates and/or performs its tasks. The sensor data can include sensor data from one or more sensors described with reference to FIG. 1. As an example, in a warehouse setting the route could include a plurality of stops along a route for the picking and loading and/or the unloading of objects, e.g., payload of goods. The route can include a plurality of path segments, including a zone for the acquisition or deposition of objects. Supervisor 200 can also monitor AMR 100, such as to determine the AMR's location within the environment, battery status and/or fuel level, and/or other operating, vehicle, performance, and/or load parameters.

As described above, a route may be developed by training AMR 100. That is, an operator may guide AMR 100 through a travel path within the environment while the AMR, through a machine-learning process, learns and stores the route for use in task performance and builds and/or updates an electronic map of the environment as it navigates, with the route being defined relative to the electronic map. The route may be stored for future use and may be updated, for example, to include more, less, or different locations, or to otherwise revise the travel route and/or path segments, as examples.

As is shown in FIG. 2, in example embodiments, AMR 100 includes various functional elements, e.g., components and/or modules, which can be housed within housing 115. Such functional elements can include at least one processor 10 coupled to at least one memory 12 to cooperatively operate the vehicle and execute its functions or tasks. Memory 12 can include computer program instructions, e.g., in the form of a computer program product, executable by processor 10. Memory 12 can also store various types of data and information. Such data and information can include route data, path data, path segment data, pick data, location data, environmental data, and/or sensor data, as examples, as well as the electronic map of the environment. In some embodiments, memory 12 stores relevant measurement data for use by a destination and path planning module 185. In some embodiments, the destination and path planning module 185 is part of a controller, for example, industrial controller 312 described with respect to FIG. 3.

In this embodiment, processor 10 and memory 12 are shown onboard AMR 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across the supervisor 200, other vehicles, and/or other systems external to the robotic vehicle 100.

The functional elements of AMR 100 can further include a navigation module 170 configured to access environmental data, such as the electronic map, and path information stored in memory 12, as examples. Navigation module 170 can communicate instructions to a drive control subsystem 120 to cause AMR 100 to navigate its route by navigating a path within the environment. During vehicle travel, navigation module 170 may receive information from one or more sensors 150, via a sensor interface (I/F) 140, to control and adjust the navigation of the AMR. For example, sensors 150 may provide 2D and/or 3D sensor data to navigation module 170 and/or drive control subsystem 120 in response to sensed objects and/or conditions in the environment to control and/or alter the AMR's navigation. As examples, sensors 150 can be configured to collect sensor data related to objects, obstructions, equipment, goods to be picked, hazards, completion of a task, and/or presence of humans and/or other robotic vehicles. An object can be a pickable or non-pickable object within a zone used by the vehicle, such as a palletized load, a cage with slots for forks at the bottom, a container with slots for forks located near the bottom and at the center of gravity for the load. Other objects can include physical obstructions in a zone such as a traffic cone or pylon, a person, and so on.

A safety module 130 can also make use of sensor data from one or more of sensors 150, in particular, LiDAR scanners 154, to interrupt and/or take over control of drive control subsystem 120 in accordance with applicable safety standard and practices, such as those recommended or dictated by the United States Occupational Safety and Health Administration (OSHA) for certain safety ratings. For example, if safety sensors detect objects in the path as a safety hazard, such sensor data can be used to cause the drive control subsystem 120 to stop the vehicle to avoid the hazard.

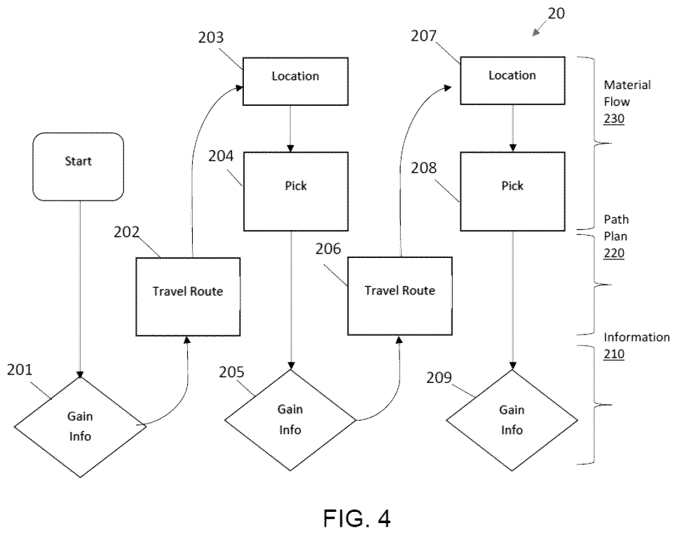

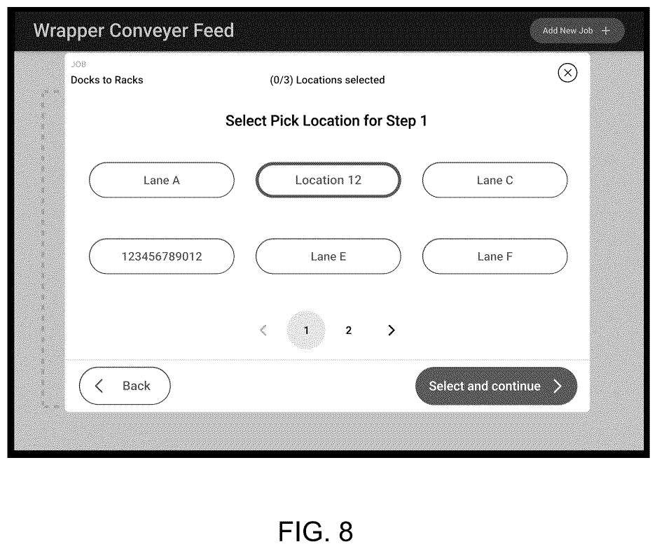

In various embodiments, the destination and path planning module 185 can execute one or more steps of the methods described in FIGS. 4, 6, and 7. For example, the destination and path planning module 185 can process received inputs including information about route, destination, and robotic actions during execution of a task, i.e., along a route, rather than prior to starting the task. The module 185 can also manage multiple delayed inputs to a task plan from one or more different user interfaces, for example, described below. In some embodiments, the system may include at least one user interface 190. The user interface 190 may present an interactive screen to an operator with a template allowing the operator to enter one or more steps, each of which includes one or more elements, or instructions, for example, regarding a pick, drop, wait, hitch, unhitch, lift, exchange, or the like. FIG. 8 illustrates an example of such an interactive screen.

As shown in FIGS. 1 and 2, in various embodiments, the system can comprise a mobile robotics platform, such as an AMR, at least one sensor 150 configured to collect/acquire point cloud data, such as a LiDAR scanner or 3D camera; and at least one local processor 10 configured to process, interpret, and register the sensor data relative to a common coordinate frame. For example, scans from the sensor 150, e.g., LiDAR scanner or 3D camera, are translated and rotated in all six degrees of freedom to align to one another and create a contiguous point cloud. To do this, a transform is applied to the data. The sensor data collected by sensors 150 can represent objects using the point clouds, where points in a point cloud represent discrete samples of the positions of the objects in 3-dimensional space. AMR 100 may respond in various ways depending upon whether a point cloud based on the sensor data includes one or more points impinging upon, falling within an envelope of, or coincident with the 3-dimensional path projection (or tunnel) of AMR 100.

FIG. 3 illustrates an example of a warehouse environment in which embodiments of the present inventive concepts can be practiced. In example embodiments, a material flow system in accordance with principles of the inventive concepts may be implemented in a facility such as a manufacturing, processing, or warehouse facility, for example. For brevity and clarity of description the example embodiments described herein will generally be in reference to warehouse implementations, but inventive concepts are not limited thereto.

In the example embodiment of FIG. 3, items (not shown) can be stored in storage racks 302 distributed throughout a warehouse. Storage racks 302 may be divided into bays 304 and bays 304 may be further divided into shelves (not shown). Racks 302 may be configured to store items within bins, on any of a variety of pallets, or other materials handling storage units. The racks 302 may be single- or multi-level, for example, and may vary in width, length, and height. Staging areas (not shown) may be used to temporarily store items for shipping or receiving, respectively, to/from transportation means, such as truck or train for example, to external facilities. Rows 306 and aisles 308 provide access to storage racks 302.

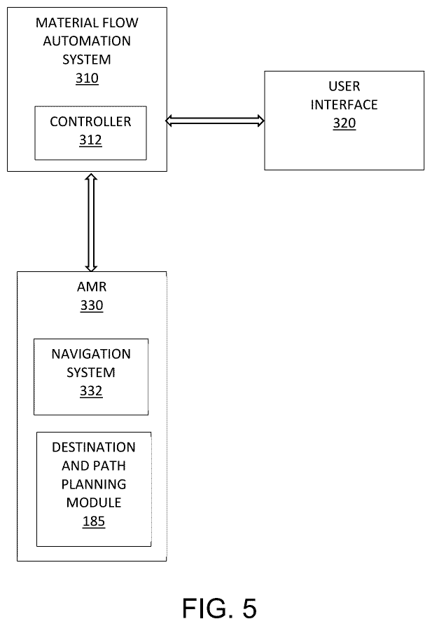

As shown, a plurality of vehicles such as AMRs 100A-100D (generally, 100) can be in communication with a fleet management system (FMS) and/or warehouse management system (WMS) 302, in accordance with aspects of inventive concepts. One or more user interfaces, for example, user interface 190 shown in FIG. 2 or user interface 320 shown in FIG. 5, may be distributed throughout the warehouse. The user interfaces may be employed by an operator to interact with a system such as one described in the discussion related to FIG. 2 to direct a vehicle to pick an item from one location (a specific storage rack, for example) and to place it in another location (a staging area, for example). The user interfaces 190 may be included within AMRs, may be in standalone screens or kiosks positioned throughout the warehouse, may be handheld electronic devices, or may be implemented as applications on smartphones or tablets, for example. One or more humans (not shown) may also work within the environment and communicate with the WMS 301, for example, via a user interface. The humans and the AMRs 100 can also communicate directly, in some embodiments. In some embodiments, the humans can order pickers that load goods on AMRs at pick locations within the warehouse environment. The humans may employ handheld electronic devices through which they can communicate with the WMS and/or the AMRs.

The AMRs 100 can operate according to route, destination, and robotic actions determined by embodiments of the systems and methods herein. For example, an AMR 100 may travel along a first predetermined route, for example, according to the process described in FIG. 4, and in doing so can use its cameras, sensors, processors, and autonomous technology, e.g., shown in FIGS. 1 and 2, to collect information that can be used for a subsequent pick or drop, which may be unknown while a location of the subsequent pick or drop is known. A material flow planning system may be implemented in the WMS/FMS 301 or implemented as part of an automation system in communication with the WMS/FMS 301, for example, implemented at supervisor 200 shown in FIG. 2, to collect information from the AMR during the first predetermined route to produce a pattern language that may be used for modeling the material flow based on the information gathered in connection with the first predetermined route. The pattern language can be used to establish repeatable patterns of movement, i.e., a second and subsequent predetermined routes. The FMS and/or WMS, either one or both of which may be implemented on supervisory processor 200, can wirelessly communicate with all of the AMRs 100 and monitor their status, assign a next task, and/or instruct navigation or a non-work location. Accordingly, a system controlling the AMRs 100, for example, some or all of which may be implemented in a combination of the WMS/FMS 301 and AMRs 100, may operate according to a pattern language generated for modeling a material flow to accommodate the varying system requirements. The pattern language may be used for modeling the material flow to increase speed, allow for replicability, and reduce cost in delivering the material flow automation solution regardless of the unique indoor environment.

FIG. 4 is a flow diagram of a material flow automation process 20, in accordance with aspects of inventive concepts. In describing the flow diagram, reference is made to an AMR 100 shown in FIGS. 1-3, which may be programmed to travel along a route according to a just-in-time destination definition and route planning process and to perform operations of an indoor material flow. Some or all of the process 20 can be implemented as program code stored and executed by a combination of an AMR 100, WMS/FMS 201, and supervisor 200 of FIGS. 2 and 3. In some embodiments, the process 20 is performed in a navigation module 170, destination and path planning module 185, and the user interface 190 of FIG. 2. One example of an operation is where the AMR 100 removes objects from a pallet and places them at a different location such as a floor, conveyor, table, and so on, for example, performing a deposition of a pallet including a payload including objects in a load drop mode. Another example is where the AMR picks a pallet off the floor, rack, table, etc., for example, removal of a pallet including a payload including objects in a load engagement mode. The process, which may be executed by one or more processors shown in FIG. 2, may include material flow 210, path plan 220, and information gathering 230 stages for modeling repeatable tasks for an AMR 100 to perform. In some embodiments, one or more sensors 150, in particular, navigation cameras and pallet detection system sensors, are used for at least the information gathering stage 210.

The process 20 can begin with the AMR 100 collecting data as it navigates a travel route (204) from a current location to a new location. The decision diamonds in FIG. 2 are indicative of a known and an unknown status that can be applied to the core elements of the material flow, e.g., the pick and drop elements in the flow 210 stage, and travel route elements of the path plan 220 and material flow 230 stages, respectively, and in doing so may allow the process 20 to identify one or more repeatable patterns of movement. The process 20 can distinguish known states from unknown states. The information needed to fill out process 20, i.e., pick and drop pallets, objects, etc. on a route, are provided by humans. The pick and drop steps are contained within the flow tier 230 because they are part of the “material flow” of a facility. When the necessary information to define a route is provided, this is referred to as a known route. If there is missing information, e.g., the drop location is not known, that still needs to be informed by a human, this is referred to as an unknown route. For example, the process recognizes when there is uncertainty as to where the material flow occurs, and also recognizes when a certainty about a path or destination is known upfront, prior to a motion or commencement of navigation of the AMR.

If a location or travel path is unknown under the path plan 220 stage, for example, a location where a pick or drop operation is planned, the AMR 100 can start movement and information necessary for determining the location or travel path can be received while the AMR 100 is in motion. The robot can travel as far down a route as is known. For example, if the pick location is known but the drop step is still unknown, the robot can still proceed and do the pick and then wait until an operator tells us where to drop.

For example, if a travel route 202 is unknown, then the collected data can be processed to determine a travel route to pick 203. At a new location, the AMR may perform a pick operation. The information about the pick 203 can be collected, for example, by cameras and/or other sensors 150 of the AMR 100 shown in FIG. 1, and provided to a system illustrated in FIG. 5, where it can be processed for planning a travel route 202. Modeling can be performed by a person evaluating a new site and is qualitative in nature. In doing so, the operator may inquire as to what kind of each of the core elements 202-206 is happening and based on which and whether they are known or not, they match that to an existing pattern.

Thus, if an operator incorporates known and unknown information about the core elements for modeling, e.g., so that the core elements are matched to an existing pattern, the AMR knows how to get to every location that has been trained in the system. Thus, if an operator selects a location to send the AMR to, the robot can compute what travel path to take to arrive there based on the trained path network, which is stored with a plurality of possible paths and permutations of paths in its memory. Although a location may not be unknown from the AMR's perspective with respect to being trained to arrive at the location. The location here is not known in advance with respect to the operator directing the AMR to the location for a given route in advance. The location is unknown in advance because the operator still does not know the necessary information and is responding to the unpredictable flow of materials in the facility throughout a time period, for example, during the day. Operators inform the AMRs where to go as they learn the information for providing to the AMRs. For example, a semi-truck just arrived, and they want the AMRs to start moving the material that was unloaded from it. An operator can now inform the AMRs to do so by telling them to pick pallets at the dock location.

As shown in FIG. 5, a system may include a material flow planning system 310 and a user interface 320 that allow a user to input details about route, destination, and robotic action during execution of a task performed by an AMR 330, rather than requiring all of the information prior to starting the task. An example is illustrated in FIG. 8. In some embodiments, the AMR 330 of FIG. 5 is similar to or the same as the AMR 100 in FIGS. 1 and 2. The user interface 320 can be deployed at one or more different computers, for example, storing and processing different browsers, so that the system can manage multiple delayed inputs to a task plan from one or more different user interfaces 320.

In some embodiments, the AMR 330 can perform repeatable tasks modeled by the system, for example, executed by the process 20 of FIG. 4. When creating the fundamental building blocks, if a job is fully pre-defined and does not require any additional information at runtime, it can be configured as such. If such a job exists, in various embodiments, the AMR 330 will perform the work without seeking any additional information from the user/another part of the system. If, however, the job is not fully known upfront, it can be configured in such away that it will seek input from a user via the user interface 320 at the AMR or other device accessible by the user or from another part of the system, e.g., one or more sensors 150, at runtime. If the additional information comes from another part of the system, it will automatically be provided as soon as it's known so that the job can make as much progress as possible. If the additional information is provided by an operator, it is entered via the user interface 320. The user interface 320 can be constructed and arranged to require the minimum amount of information needed in order to complete the job and is done in a language that is intuitive to the user. Accordingly, the system can be used by a customer to allow AMRs to complete as much of a job as possible with the information that it has, and as new information is made available, the AMR is able to continue performing the job.

As shown in FIG. 5, the user interface 320 communicates with a material flow planning system 310 has an industrial controller 310 for controlling the AMR(s) 330 or other mechanism that includes a computer processor or the like for executing instructions of an instruction set of the methods of FIGS. 4, 6, and 7. The material flow planning system 310 may include an industrial controller 312 that communicates with the AMR 330 via an application programming interface (API) or the like to send instructions of an instruction set to the AMR 330 in response to the methods of FIGS. 4, 6, and 7. For example, the controller 312 can send a signal that a path or location is determined according to a repeatable pattern of a material flow determined by a pattern language based on a combination of flow patterns determined from stored historical data and fundamental flow patterns based on public traffic systems or the like. The AMR 330 may include a navigation system 332 that navigates the AMR 330 in response to the instructions provided via the user interface 320.

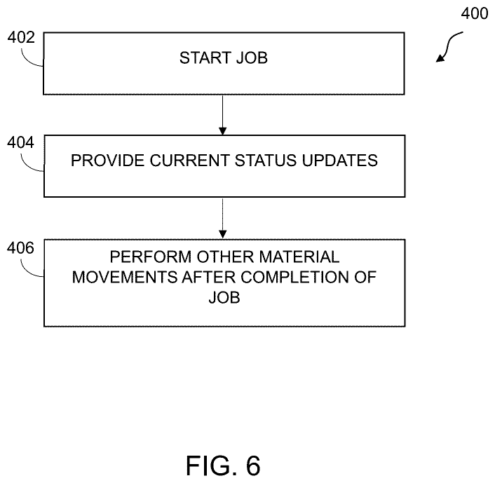

FIG. 6 is a flow diagram of a method 400 for performing a material flow job by an AMR, in accordance with some embodiments. In describing the method 400, reference is made to elements of the system of FIG. 5. The user interface 320 allows a user to enter the required information to complete a job. The user interface 320 can exist and run on multiple browsers. This allows many different users from across a facility to enter information about a job without having everything be centralized to one instance. The system can handle and prevent different users from entering and overwriting information that was entered by someone else.

At block 402, a user can start a job in the user interface 320 and a job is able to be started automatically by the industrial controller 312. Once the job has been started, at block 404, the user interface 320 can provide updates about the current status of all running jobs on a predetermined periodic basis, for example, every second. As the jobs progress through various stages, details thereof can be displayed in the user interface 320. Once a job has been started, at any point up to and including the point of the AMR 330 sitting idle waiting for the needed information, a user can enter the required information into the user interface 320. At block 406, after the AMR 330 has finished the job, it is then free to perform other material movements.

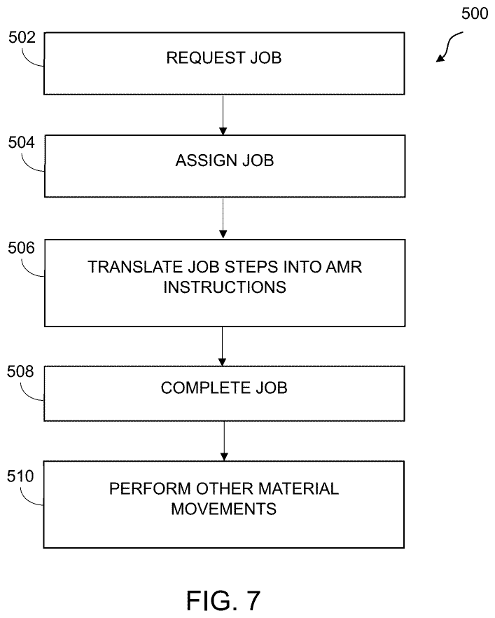

FIG. 7 is a flow diagram of a method 500 for starting a material flow job and entering information to a running job, in accordance with some embodiments. In describing the method 500, reference is made to elements of the system of FIG. 5.

At block 502, a job is requested via a configured trigger, for example, initiated by the industrial controller 312, the user interface 320, and/or other element of the system of FIG. 5. A user-configurable job can be requested via a configurable trigger, such as an operator request or programmable logic controller (PLC) request. For example, a user may place as many requests for this job via the user interface 320 as are required.

the specific location to which the AMR is to travel may not be known until after the job is triggered, an operator may instead provide a set of possible locations and an indication of the source from which the specific location will be obtained, e.g., from an operator at a specific user interface, for example), from a processor configured as a fleet manager, or from an external system. In doing so, at block 504, the job is assigned to the best available AMR 330 among a plurality of AMRs 100, for example, shown in FIG. 3. If an AMR 330 is not immediately available for assignment, the job request is queued until an AMR 330 becomes available.

At block 506, the system translates the job's steps into a set of instructions that the AMR 330 is able to understand. For example, for an AMR 330, the step's location is translated to an action, such as a pick, drop, wait, hitch, unhitch, lift, exchange, and so on, that has been trained on the AMRs at a specific physical location in the facility and instructs the AMR 330 to go there. The system can output AMR-specific commands to the AMR 330 at the correct time. For example, the AMRs can be dispatched when they are sitting idle at a station. The system enforces these policies, which the user never has to consider. At some point during the AMR's route, the information needed to finish the job is entered into the user interface 320.

The AMR 330 continues performing the previously initiated job. At block 508, when the AMR 508 is finished doing what it was previously doing, one of two events may occur. If a user entered the needed information, it would immediately continue the job as far as it can with the information that it knows. If a user has not entered the needed information, the AMR will sit idle waiting for the information it needs to continue to work on the job.

At block 510, after the system is done sending commands to the AMR 330 and the job is complete then the AMR 330 is available for new work.

Although the foregoing describes a material flow environment, embodiments of the inventive concepts can apply to other applications, for example, any field where automation is used. For example, embodiments of the inventive concepts can be used in an application like an Uber™ vehicle where you have a group of people who have not decided where they are going yet but know that they're going somewhere and want to have a car start driving towards them as they make a decision about where they want to go.

While the foregoing has described what are considered to be the best mode and/or other preferred embodiments, it is understood that various modifications can be made therein and that aspects of the inventive concepts herein may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the inventive concepts, which are, for clarity, described in the context of separate embodiments, may also be provided in combination in a single embodiment. Conversely, various features of the inventive concepts which are, for brevity, described in the context of a single embodiment may also be provided separately or in any suitable sub-combination.

For example, it will be appreciated that all of the features set out in any of the claims (whether independent or dependent) can be combined in any given way.

Below follows an itemized list of statements describing embodiments in accordance with the inventive concepts:

1. A system, comprising:
an input device that provides an instruction set regarding at least one destination of interest to at least one processor;
a navigation system that navigates a vehicle in response to the instruction set; and
a controller that initiates a material flow task to be executed by the vehicle, wherein the controller receives at least one instruction of the instruction set during the execution of the material flow task by the vehicle.

2. The system of statement 1, or any other statement or combinations of statements, wherein the vehicle is an autonomous mobile robot (AMR).

3. The system of statement 1, or any other statement or combinations of statements, wherein the instruction set is output to the AMR, and a machine or human operator of the AMR controls the navigation system according to the instruction set.

4. The system of statement 1, or any other statement or combinations of statements, wherein a task plan includes data about the material flow task and includes a combination of known and unknown information about a route, destination, and robotic action of the material flow task.

5. The system of statement 4, or any other statement or combinations of statements, wherein the input device communicates with a plurality of different input sources, and wherein the controller parses and prioritizes multiple delayed inputs of the different input sources to the task plan.

6. The system of statement 4, or any other statement or combinations of statements, wherein the unknown information is resolved by the at least one instruction during the execution of the material flow task.

7. The system of statement 6, or any other statement or combinations of statements, further comprising a user interface that receives data for addressing the unknown information while the vehicle is moving along a route for performing the material flow task.

8. A method, comprising:
starting a movement by the vehicle, the vehicle includes a plan including a combination of known and unknown features of a path to at least one destination of interest;
providing instructions to the vehicle regarding information about the unknown features after the start of movement of the vehicle; and
navigating the vehicle to the at least one destination of interest.

9. The method of statement 8, or any other statement or combinations of statements, wherein the vehicle is an autonomous mobile robot (AMR).

10. The method of statement 9, or any other statement or combinations of statements, wherein the instruction set is output to the AMR, and a machine or human operator of the AMR controls the navigation system according to the instruction set.

11. The method of statement 8, or any other statement or combinations of statements, wherein a task plan includes data about the material flow task and includes a combination of known and unknown information about a route, destination, and robotic action of the material flow task.

12. The method of statement 11, or any other statement or combinations of statements, wherein the input device communicates with a plurality of different input sources, and wherein the controller parses and prioritizes multiple delayed inputs of the different input sources to the task plan.

13. The method of statement 11, or any other statement or combinations of statements, wherein the unknown data is resolved by the at least one instruction during the execution of the material flow task.

14. The method of statement 11, or any other statement or combinations of statements, further comprising receiving by a user interface data for addressing the unknown information while the vehicle is moving along a route for performing the material flow task.

15. A computer readable medium having computer executable instructions for a material flow planning system that when executed by a processor performs the following steps comprising:
starting a movement by the vehicle, the vehicle includes a plan including a combination of known and unknown features of a path to at least one destination of interest;
providing instructions to the vehicle regarding information about the unknown features after the start of movement of the vehicle; and
navigating the vehicle to the at least one destination of interest.

16. The computer readable medium of statement 15, or any other statement or combinations of statements, wherein the vehicle is an autonomous mobile robot (AMR).

17. The computer readable medium of statement 16, or any other statement or combinations of statements, wherein the instruction set is output to the AMR, and a machine or human operator of the AMR controls the navigation system according to the instruction set.

18. The computer readable medium of statement 15, or any other statement or combinations of statements, wherein a task plan includes data about the material flow task and includes a combination of known and unknown information about a route, destination, and robotic action of the material flow task.

19. The computer readable medium of statement 18, or any other statement or combinations of statements, wherein the input device communicates with a plurality of different input sources, and wherein the controller parses and prioritizes multiple delayed inputs of the different input sources to the task plan.

20. The computer readable medium of statement 18, or any other statement or combinations of statements, wherein the unknown data is resolved by the at least one instruction during the execution of the material flow task.

What is claimed is:

1. A system, comprising:
an input device that provides an instruction set regarding at least one destination of interest to at least one processor;
a navigation system that navigates a vehicle in response to the instruction set; and
a controller that initiates a material flow task to be executed by the vehicle, wherein the controller receives at least one instruction of the instruction set during the execution of the material flow task by the vehicle.

2. The system of claim 1, wherein the vehicle is an autonomous mobile robot (AMR).

3. The system of claim 1, wherein the instruction set is output to the AMR, and a machine or human operator of the AMR controls the navigation system according to the instruction set.

4. The system of claim 1, wherein a task plan includes data about the material flow task and includes a combination of known and unknown information about a route, destination, and robotic action of the material flow task.

5. The system of claim 4, wherein the input device communicates with a plurality of different input sources, and wherein the controller parses and prioritizes multiple delayed inputs of the different input sources to the task plan.

6. The system of claim 4, wherein the unknown information is resolved by the at least one instruction during the execution of the material flow task.

7. The system of claim 6, further comprising a user interface that receives data for addressing the unknown information while the vehicle is moving along a route for performing the material flow task.

8. A method, comprising:
starting a movement by the vehicle, the vehicle includes a plan including a combination of known and unknown features of a path to at least one destination of interest;
providing instructions to the vehicle regarding information about the unknown features after the start of movement of the vehicle; and
navigating the vehicle to the at least one destination of interest.

9. The method of claim 8, wherein the vehicle is an autonomous mobile robot (AMR).

10. The method of claim 9, wherein the instruction set is output to the AMR, and a machine or human operator of the AMR controls the navigation system according to the instruction set.

11. The method of claim 8, wherein a task plan includes data about the material flow task and includes a combination of known and unknown information about a route, destination, and robotic action of the material flow task.

12. The method of claim 11, wherein the input device communicates with a plurality of different input sources, and wherein the controller parses and prioritizes multiple delayed inputs of the different input sources to the task plan.

13. The method of claim 11, wherein the unknown data is resolved by the at least one instruction during the execution of the material flow task.

14. The method of claim 8, further comprising receiving by a user interface data for addressing the unknown information while the vehicle is moving along a route for performing the material flow task.

15. A computer readable medium having computer executable instructions for a material flow planning system that when executed by a processor performs the following steps comprising:
starting a movement by the vehicle, the vehicle includes a plan including a combination of known and unknown features of a path to at least one destination of interest;
providing instructions to the vehicle regarding information about the unknown features after the start of movement of the vehicle; and
navigating the vehicle to the at least one destination of interest.

16. The computer readable medium of claim 15, wherein the vehicle is an autonomous mobile robot (AMR).

17. The computer readable medium of claim 16, wherein the instruction set is output to the AMR, and a machine or human operator of the AMR controls the navigation system according to the instruction set.

18. The computer readable medium of claim 15, wherein a task plan includes data about the material flow task and includes a combination of known and unknown information about a route, destination, and robotic action of the material flow task.

19. The computer readable medium of claim 18, wherein the input device communicates with a plurality of different input sources, and wherein the controller parses and prioritizes multiple delayed inputs of the different input sources to the task plan.

20. The computer readable medium of claim 18, wherein the unknown data is resolved by the at least one instruction during the execution of the material flow task.
